(19) United States
(12) Patent Application Publication
(10) Pub. No.: US 2014/0312527 A1
(43) Pub. Date: Oct. 23, 2014

(54) DIE ASSEMBLIES AND DIE ASSEMBLY COMPONENTS AND METHODS OF MAKING AND USING THE SAME

(71) Applicant: Matthew C. Pelham, SR., Jefferson, GA (US)

(72) Inventor: Matthew C. Pelham, SR., Jefferson, GA (US)

(21) Appl. No.: 14/208,488

(22) Filed: Mar. 13, 2014

Related U.S. Application Data
(60) Provisional application No. 61/814,761, filed on Apr. 22, 2013.

(51) Int. Cl. B29C 47/12; B29C 47/08

(52) U.S. Cl. CPC B29C 47/12; B29C 47/085
USPC 264/211.21; 425/447; 264/219

(57) ABSTRACT

Die assemblies and die assembly components are disclosed. Methods of making and using die assemblies and die assembly components are also disclosed.

### CROSS-REFERENCE TO RELATED APPLICATIONS

This patent application claims the benefit of priority to U.S. provisional patent application Ser. No. 61/814,761 entitled “DIE ASSEMBLIES AND DIE ASSEMBLY COMPONENTS AND METHODS OF MAKING AND USING THE SAME” filed on Apr. 22, 2013, the subject matter of which is incorporated herein in its entirety.

### FIELD OF THE INVENTION

The present invention relates generally to die assemblies and die assembly components such as components suitable for forming nonwoven fabrics. The present invention further relates generally to methods of making die assemblies and die assembly components, as well as methods of using die assemblies and die assembly components.

### BACKGROUND OF THE INVENTION

FIG. 1 depicts a schematic view of an exemplary melt-blowing apparatus of the prior art showing a die assembly 10′ therein. Known melt-blowing apparatus of the prior art have a number of shortcomings including, but not limited to, (i) the use of a relatively expensive die assembly 10′ therein; (ii) the use of a relatively expensive die assembly 10′, which must be cleaned on a regular basis in order to use the die assembly 10′ for an extended length of time and/or between extrusion process runs (e.g., a first extrusion run using polypropylene and a second extrusion run using polyethylene); and (iii) the need for a relatively high energy system input so as to melt extrudant material, produce hot air, and maintain molten extrudant and hot air at desired temperatures during processing.

FIG. 2 depicts a schematic view of an exemplary die assembly 10′ of the prior art suitable for use in the exemplary melt-blowing apparatus shown in FIG. 1. Exemplary die assembly 10′ of the prior art comprises an exemplary die body 11′ of the prior art in combination with a separate and distinct (and connectable) exemplary die tip (also referred to herein as a spinneret) 12′ of the prior art. As shown in FIG. 2, in a conventional die assembly 10′ of the prior art, molten polymer is introduced into die body 11′, which then feeds multiple streams of molten polymer into die tip 12′, which attenuates the molten polymer into individual fibers (not shown).

FIG. 3 depicts a cross-sectional view of an exemplary die body 11′ of the prior art suitable for use in the exemplary melt-blowing apparatus shown in FIG. 1 and/or the exemplary die assembly 10′ shown in FIG. 2. As shown in FIG. 3, exemplary die body 11′ comprises a die body housing 20′, a single extrudant material inlet 13′, and multiple extrudant material outlets 14′ with the multiple extrudant material outlets 14′ aligned in a linear manner (i.e., molten polymer exits exemplary die body 11′ in the form of a linear blade of molten polymer streams).

FIG. 4 depicts a cross-sectional view of an exemplary die tip 12′ of the prior art suitable for use in the exemplary melt-blowing apparatus shown in FIG. 1 and/or the exemplary die assembly shown in FIG. 2. As shown in FIG. 4, exemplary die tip 12′ comprises a die tip housing 30′; a polymer feed reservoir 15′, wherein molten polymer from a die body, such as exemplary die body 11′, is introduced into exemplary die tip 12′; a nozzle 17′ extending through die tip housing 30′ (note, although a single nozzle 17′ is shown, exemplary die tip 12′ will comprise multiple nozzles 17′, typically, up to about 20-30 nozzles per linear inch 17′, extending through die tip housing 30′); at least one die tip air inlet 17′ along die tip housing 30′; and multiple die tip air outlets 18′ along die tip housing 30′. Hot air exiting multiple die tip air outlets 18′ attenuates molten extrudant material exiting nozzles 17′ so as to form fibrous material.

Efforts continue to reduce the costs of preparing extruded materials such as nonwoven webs. What is needed in the art is a die assembly and/or die assembly components, suitable for use in forming nonwoven webs, wherein the die assembly and/or die assembly component provides one or more of the following benefits: (i) the ability to be economically manufactured, (ii) the ability to provide efficient use of heat energy during a melt extrusion process, and (iii) the ability to reduce the overall cost of providing an extruded product via a melt extrusion process.

### SUMMARY OF THE INVENTION

The present invention is directed to die assemblies and components thereof. Such die assemblies and die assembly components are useful, for example, in extrusion processes such as nonwoven web-forming processes. The die assemblies and/or die assembly component of the present invention provide one or more of the following features: (i) the ability to be economically manufactured, (ii) the ability to provide efficient use of heat energy during a melt extrusion process, and (iii) the ability to reduce the overall cost of providing an extruded product via a melt extrusion process.

According to one exemplary embodiment of the present invention, the die assembly of the present invention comprises a die body comprising (i) a die body housing, (ii) a single first extrudant material inlet along an extrudant inlet surface of the die body housing, (iii) multiple first extrudant material outlets along an extrudant outlet surface of the die body housing, and (iv) a first conduit structure connecting the single first extrudant material inlet to the multiple first extrudant material outlets, the multiple first extrudant material outlets being in a non-linear configuration along the extrudant outlet surface of the die body housing. The die bodies of the present invention may be used in combination with a conventional die tip or a die tip of the present invention.

In another exemplary embodiment of the present invention, the die assembly of the present invention comprises a die body comprising (i) a die body housing, (ii) a single first extrudant material inlet along an extrudant inlet surface of the die body housing, (iii) multiple first extrudant material outlets along an extrudant outlet surface of the die body housing, (iv) a first conduit structure connecting the single first extrudant material inlet to the multiple first extrudant material outlets, and (v) void space between inner walls of the die body housing and outer surfaces of the first conduit structure. The die tips of the present invention may be used in combination with a conventional die body or a die body of the present invention.

In yet another exemplary embodiment of the present invention, the die assembly of the present invention comprises a die tip comprising (i) a die tip housing; (ii) multiple nozzles extending through the die tip housing, each of the multiple nozzles comprising (a) a nozzle inlet, (b) a nozzle outlet, (c) a nozzle conduit structure extending from the nozzle inlet to the nozzle outlet, and (d) a continuous nozzle inner surface extending from the nozzle inlet to the nozzle outlet; (iii) at least one die tip air inlet along an air inlet surface of the die tip housing; (iv) multiple die tip air outlets; and (v) a die tip air flow pathway extending from the at least one die tip air inlet to the multiple die tip air outlets, the die tip air flow pathway being in fluid communication with an outer surface of each of the multiple nozzles; wherein the die tip further comprises at least one of the following features: (1) air flow adjusters promimate to or connected to one or more of the multiple nozzles, the air flow adjusters being operatively adapted to cause rotational air flow along the outer surface of the one or more multiple nozzles as air exits the die tip air outlets associated with the one or more multiple nozzles; (2) a non-circular cross-sectional area for one or more nozzle holes as measured substantially perpendicular to the continuous nozzle inner surface of the nozzle conduit structure; (3) a nozzle inlet cross-sectional area that is greater than a nozzle outlet cross-sectional area for a nozzle conduit structure within the multiple nozzles as measured substantially perpendicular to the continuous nozzle inner surface of the nozzle conduit structure; (4) one or more nozzle stabilizers integrally connecting an outer surface of a given nozzle conduit structure to the die tip housing proximate the multiple die tip air outlets of the die tip housing; and (5) the continuous nozzle inner surface has a length to diameter ratio greater than about 5:1.

The present invention is further directed to methods of making a die assembly or a component thereof via a three-dimensional printing step. In one exemplary embodiment of the present invention, the method of making a die assembly comprises forming a pre-formed die assembly via one or more three-dimensional printing steps. The method may further comprise a number of additional steps including, but not limited to, heating the pre-formed die assembly at a temperature and period of time so as to consolidate (e.g., sinter) the pre-formed die assembly into the die assembly.

The present invention is even further directed to methods of using die assemblies. In one exemplary embodiment of the present invention, the method of the present invention comprises extruding a material through the die assembly. For example, the material may comprise at least one polymeric material. The extruding step may form a nonwoven fabric or another article of manufacture.

These and other features and advantages of the present invention will become apparent after a review of the following detailed description of the disclosed embodiments and the appended claims.

### BRIEF DESCRIPTION OF THE FIGURES

The present invention is further described with reference to the appended figures, wherein:

FIG. 1 depicts a schematic view of an exemplary melt-blowing apparatus of the prior art showing a die assembly therein;

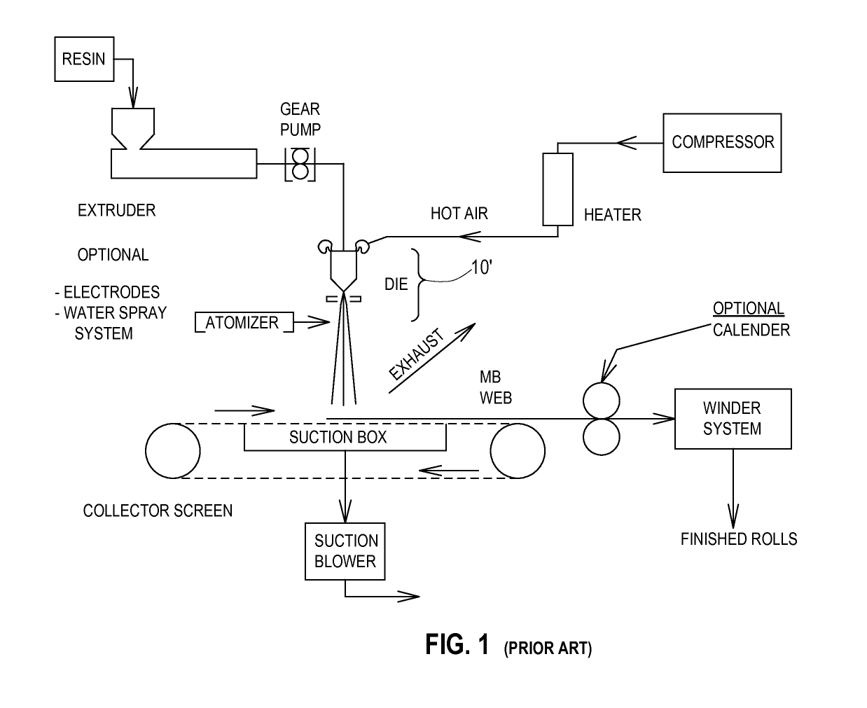

FIG. 2 depicts a schematic view of an exemplary die assembly of the prior art suitable for use in the exemplary melt-blowing apparatus shown in FIG. 1;

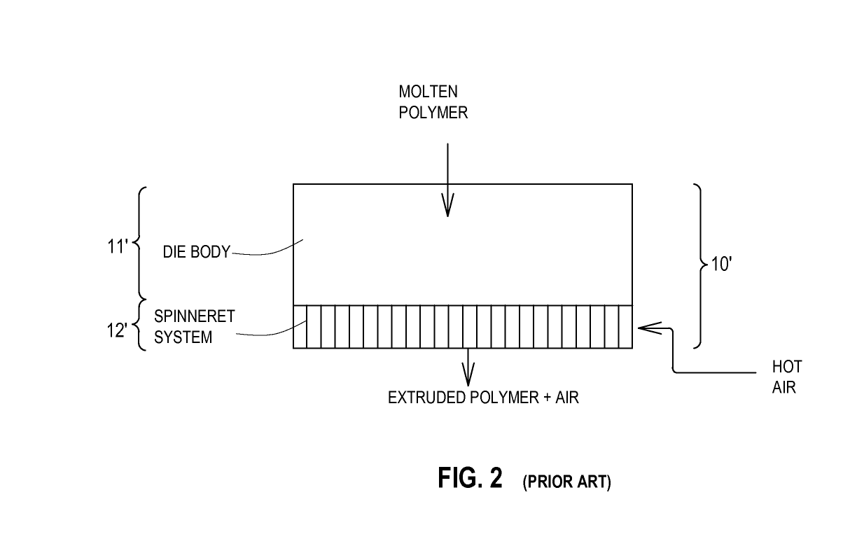

FIG. 3 depicts a cross-sectional view of an exemplary die body of the prior art suitable for use in the exemplary melt-blowing apparatus shown in FIG. 1 and/or the exemplary die assembly shown in FIG. 2;

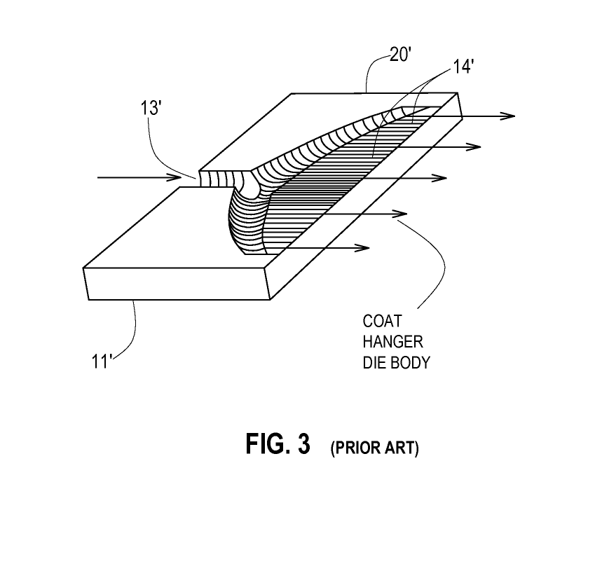

FIG. 4 depicts a cross-sectional view of an exemplary die tip of the prior art suitable for use in the exemplary melt-blowing apparatus shown in FIG. 1 and/or the exemplary die assembly shown in FIG. 2;

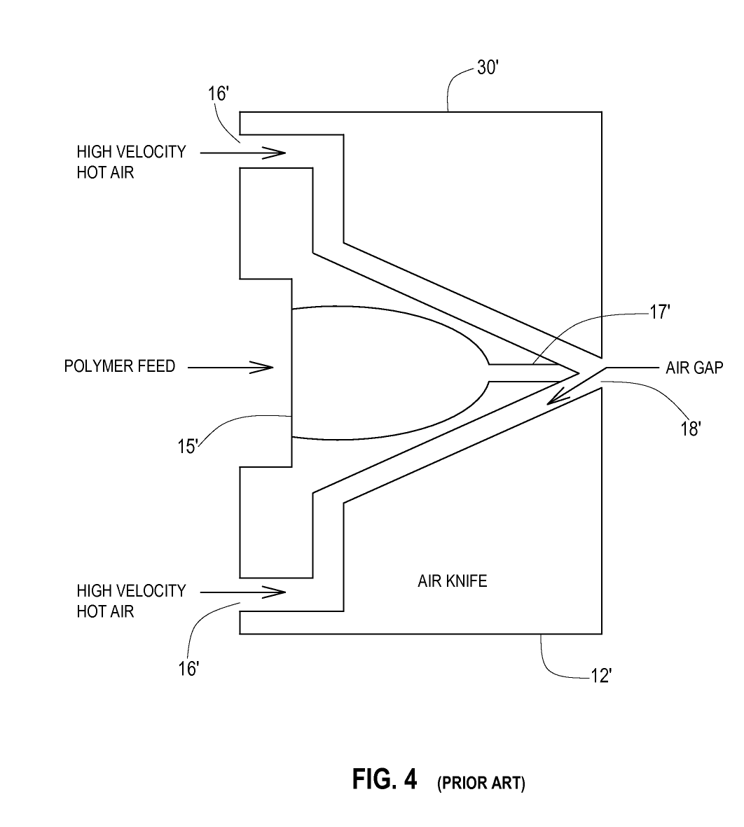

FIG. 5 depicts an exemplary die body of the present invention suitable for use in the exemplary melt-blowing apparatus shown in FIG. 1 and/or the exemplary die assembly shown in FIG. 2;

FIG. 6 depicts a cross-sectional view of exemplary die body shown in FIG. 5 as viewed along line 6-6 shown in FIG. 5;

FIG. 7A depicts a bottom view of the exemplary die body shown in FIG. 5;

FIG. 7B depicts an exploded view of a portion of the exemplary die body shown in FIG. 7A;

FIG. 8 depicts a cross-sectional view of another exemplary die body suitable for extruding two different materials;

FIG. 9 depicts a partial cross-sectional view of an exemplary die tip of the present invention suitable for use in the exemplary melt-blowing apparatus shown in FIG. 1 and/or the exemplary die assembly shown in FIG. 2;

FIGS. 10A-10C depict a variety of exemplary nozzle cross-sectional configurations suitable for use in the exemplary die tip shown in FIG. 9;

FIG. 11 depicts a bottom view of the exemplary die tip shown in FIG. 9;

FIG. 12 depicts optional exemplary air flow adjusters suitable for use in the exemplary die tip shown in FIG. 9; and

FIG. 13 depicts a partial cross-sectional view of an exemplary die assembly of the present invention suitable for use in the exemplary melt-blowing apparatus shown in FIG. 1, the exemplary die assembly comprising components of the exemplary die body shown in FIG. 5 integrally combined with components of the exemplary die tip shown in FIG. 9.

### DETAILED DESCRIPTION OF THE INVENTION

The present invention is directed to die assemblies and components thereof. The present invention is further directed to methods of making and using die assemblies and components thereof. The die assemblies of the present invention are particularly useful for forming articles such as nonwoven webs including melt-blown fabrics.

### I. Die Assemblies and Components Thereof

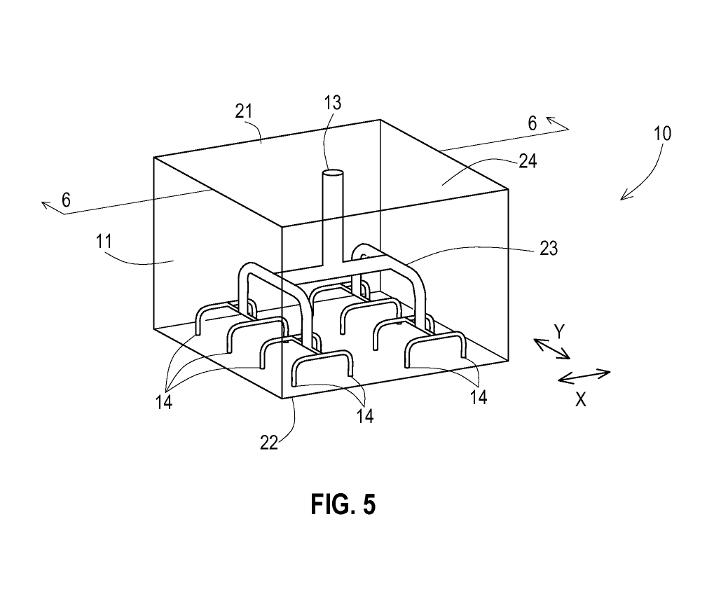

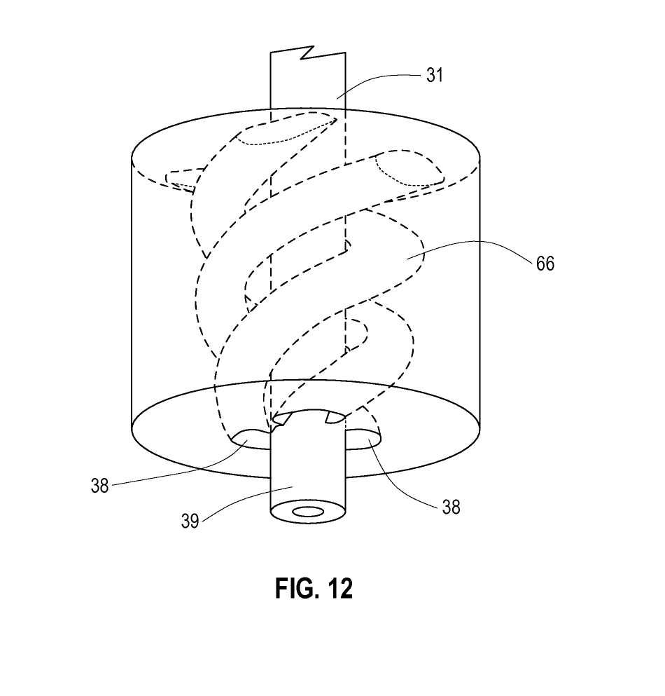

The present invention is directed to die assemblies and components thereof. Exemplary die assemblies 10 of the present invention are shown in FIGS. 5-13, and described in detail below.

### II. Methods of Making Die Assemblies

The present invention is further directed to methods of making die assemblies 10 and components thereof. In one exemplary embodiment of the present invention, the method of making a die assembly 10 comprises forming a pre-formed die assembly via one or more three-dimensional printing steps. The method may further comprise a number of additional steps including, but not limited to, heating the pre-formed die assembly at a temperature and period of time so as to consolidate the pre-formed die assembly into the die assembly 10.

### III. Methods of Using Die Assemblies

The present invention is further directed to methods of using the above-described die assemblies 10 and components thereof (e.g., the above-described die body 11, the above-described die tip 12, the above-described die assembly 10, etc.). In one exemplary embodiment of the present invention, the method comprises extruding a material through the die assembly 10. For example, the material may comprise at least one polymeric material (e.g., any extrudable polymeric material such as a polyolefin, a polyester, or any combination thereof). The extruding step may form fibrous material, for example, in the form of a nonwoven fabric or another article of manufacture comprising extruded material.

Although not shown in the figures, die assemblies 10 and components thereof (e.g., the above-described die body 11, the above-described die tip 12, the above-described die assembly 10, etc.) may be designed and prepared so as to extrude (i) a single polymeric material so as to form monocomponent fibers, (ii) a blend of two or more polymeric materials so as to form bi- or multi-component fibers (e.g., with an island-in-the-sea configuration), or (iii) two or more polymeric materials introduced into one or more nozzles 31 so as to form bi- or multi-component fibers having a more structured cross-sectional configuration (e.g., with a sheath/core cross-sectional configuration or a segmented pie cross-sectional configuration). Exemplary bi-component fibers include, but are not limited to, (i) sheath/core fibers having a co-polyester sheath and a polyester core, and (ii) sheath/core fibers having a co-polyamide sheath and a polyamide core.

Die assemblies 10 of the present invention may be utilized in a number of conventional extrusion processes including, but not limited to, meltblowing processes, spunbonding processes, spunlacing processes, etc.

The present invention is further directed to the additional embodiments as described below.

### ADDITIONAL EMBODIMENTS

Die Assembly Embodiments

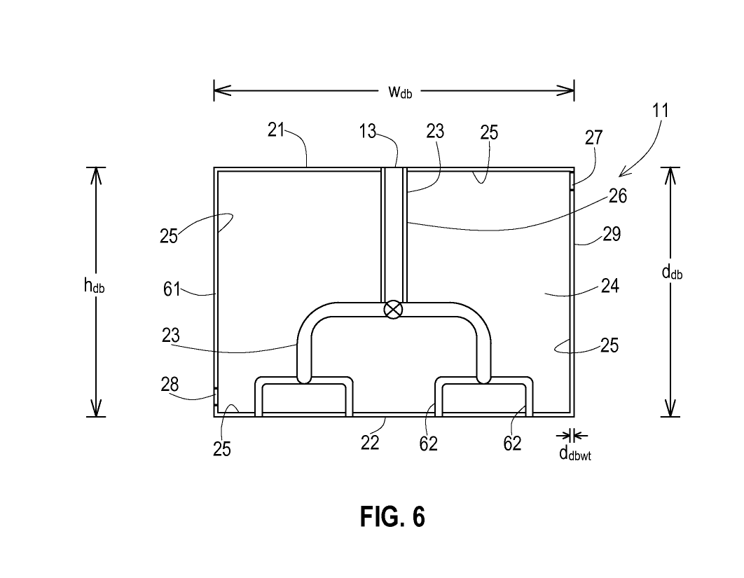

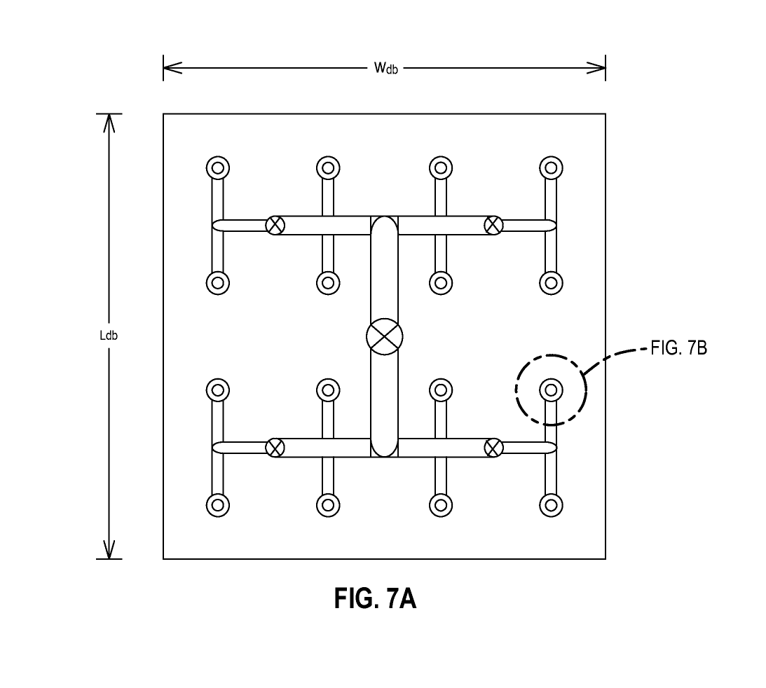

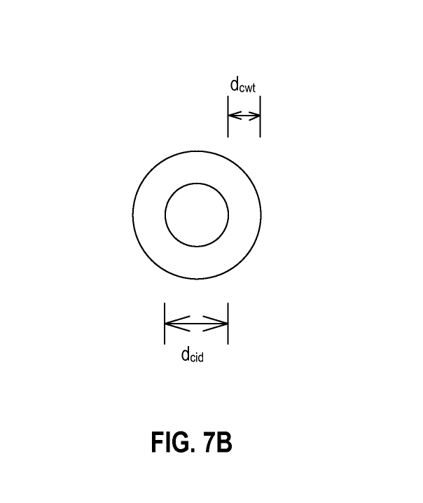

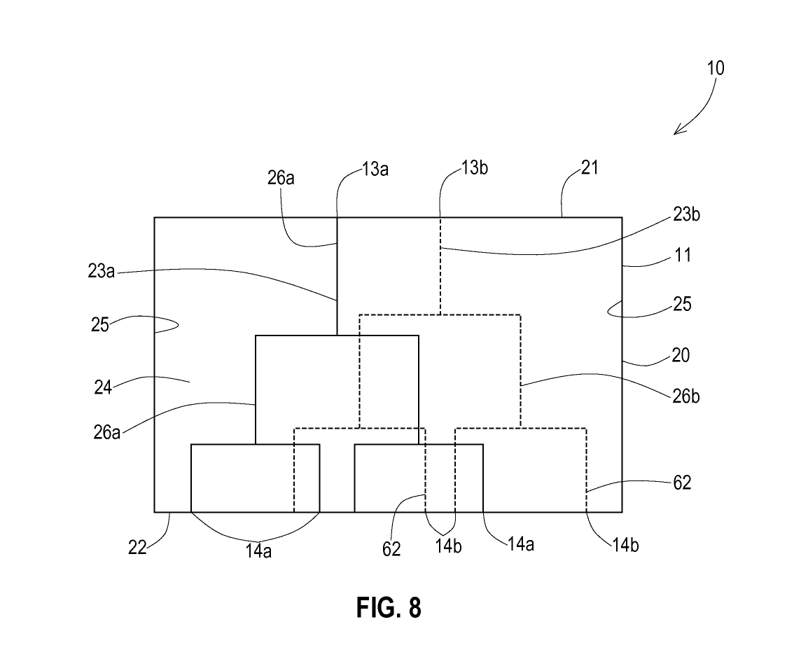

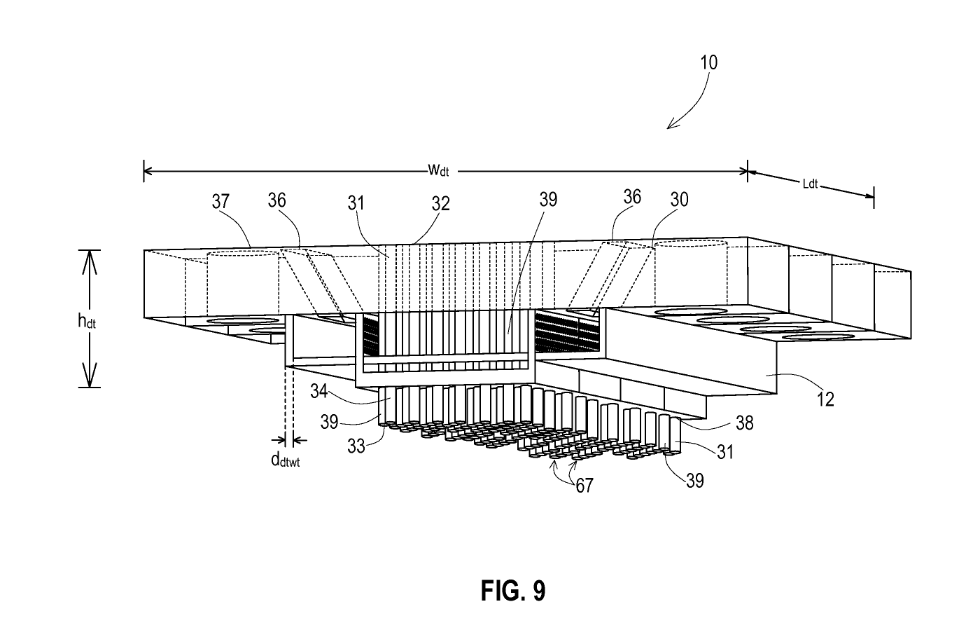

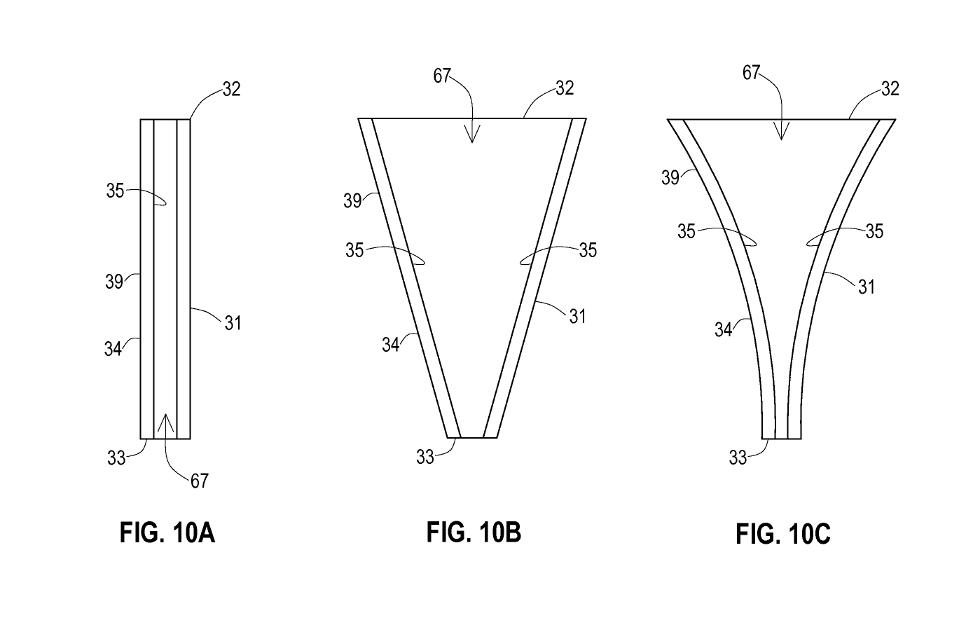

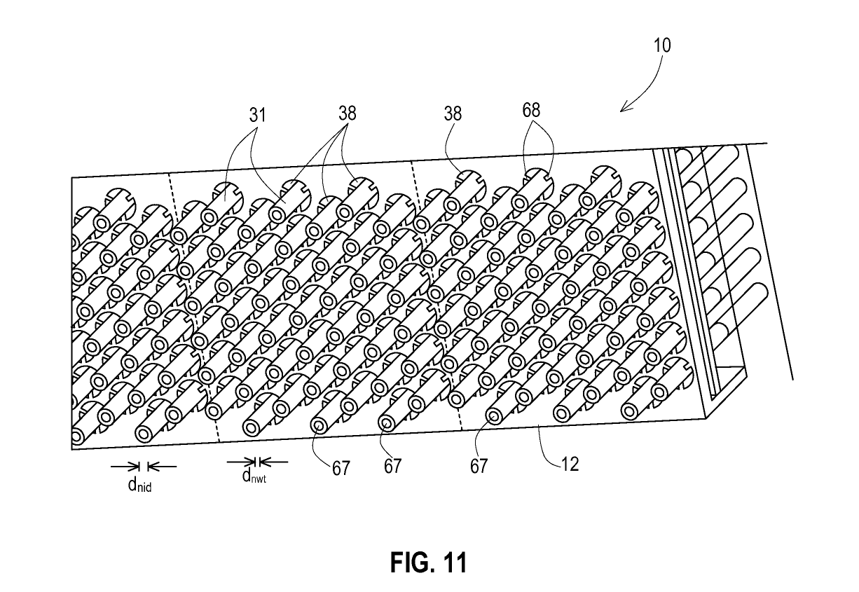

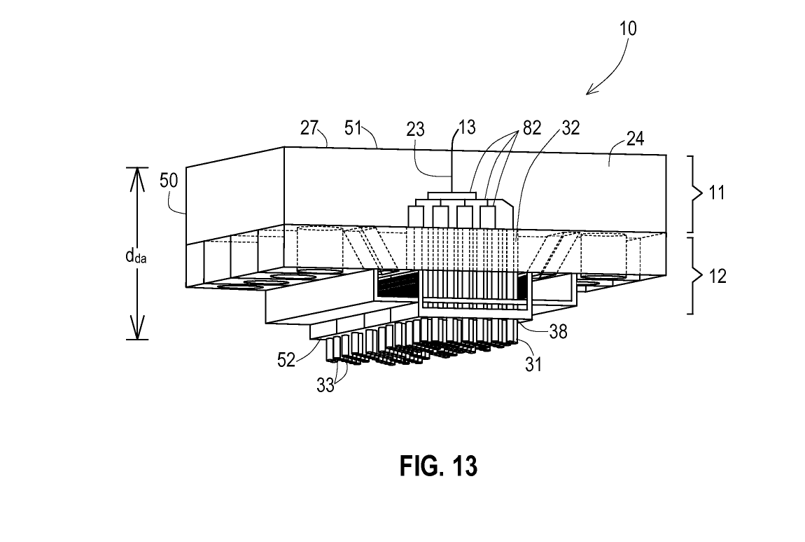

1. A die assembly 10 comprising: a die body 11 comprising (i) a die body housing 20, (ii) a single first extrudant material inlet 13 along an extrudant inlet surface 21 of said die body housing 20, (iii) multiple first extrudant material outlets 14 along an extrudant outlet surface 22 of said die body housing 20, and (iv) a first conduit structure 23 connecting said single first extrudant material inlet 13 to said multiple first extrudant material outlets 14, said multiple first extrudant material outlets 14 being in a non-linear configuration along said extrudant outlet surface 12 of said die body housing 20. As shown in FIG. 5, multiple first extrudant material outlets 14 are shown in a non-linear configuration, namely, a 4×4 array of first extrudant material outlets 14, along extrudant outlet surface 12 of die body housing 20.
2. The die assembly 10 of embodiment 1, wherein said die body 11 further comprises (v) void space 24 between inner wall surfaces 25 of said die body housing 11 and outer surfaces 26 of said first conduit structure 23. See, FIG. 6.
3. A die assembly 10 comprising: a die body 11 comprising (i) a die body housing 20, (ii) a single first extrudant material inlet 13 along an extrudant inlet surface 21 of said die body housing 20, (iii) multiple first extrudant material outlets 14 along an extrudant outlet surface 22 of said die body housing 11, (iv) a first conduit structure 23 connecting said single first extrudant material inlet 13 to said multiple first extrudant material outlets 14, and (v) void space 24 between inner wall surfaces 25 of said die body housing 11 and outer surfaces 26 of said first conduit structure 23.
4. The die assembly 10 of embodiment 3, wherein said multiple first extrudant material outlets 14 are in a non-linear configuration along said extrudant outlet surface 22 of said die body housing 11.
5. The die assembly 10 of any one of embodiments 1 to 4, wherein said first multiple extrudant material outlets 14 comprise at least three first extrudant material outlets 14. Typically, said first multiple extrudant material outlets 14 comprise from about three first extrudant material outlets 14 to about 1024 first extrudant material outlets 14, or any number in increments of 1 therebetween, or any range between 3 and 1024, e.g., from about 16 to about 128 first extrudant material outlets 14,
6. The die assembly 10 of any one of embodiments 1 to 5, wherein said multiple first extrudant material outlets 14 comprise four or more first extrudant material outlets 14 in multiples of 2 (e.g., 4, 8, 16, etc. material outlets 14).
7. The die assembly 10 of any one of embodiments 1 to 6, wherein said multiple first extrudant material outlets 14 comprise from about 16 to about 128 first extrudant material outlets 14, or any number between 16 and 128, in increments of 1, or any range between 16 and 128, e.g., from about 32 to about 64.
8. The die assembly 10 of any one of embodiments 1 to 7, wherein said multiple first extrudant material outlets 14 form an array of first extrudant material outlets 14 along said extrudant outer surface 22, said array comprising (i) at least two first extrudant material outlets 14 in a x direction and (ii) at least two first extrudant material outlets 14 in a y direction.
9. The die assembly 10 of any one of embodiments 1 to 8, wherein said multiple first extrudant material outlets 14 form an array of first material extrudant outlets 14 along said extrudant outer surface 22, said array comprising (i) at least four first extrudant material outlets 14 in a x direction and (ii) at least four first extrudant material outlets 14 in a y direction.
10. The die assembly 10 of any one of embodiments 1 to 9, wherein said extrudant inlet surface 21 is substantially within a first plane, said extrudant outlet surface 22 is within a second plane, and said first plane is substantially parallel with said second plane.
11. The die assembly 10 of embodiment 10, wherein said first plane is separated from said second plane by a housing distance, d_{db}, ranging from about 0.5 centimeters (cm) up to and including about 40.0 cm, or any number between 0.5 and 40.0 cm, in increments of 0.1 cm, or any range between 0.5 and 40 cm, e.g., from about 2.5 to about 10.0 cm.
12. The die assembly 10 of any one of embodiments 1 to 11, wherein said first conduit structure 23 has an average first conduit wall thickness, d_{cwt}, ranging from about 0.1 millimeters (mm) up to and including about 5.0 mm, or any number between 0.1 and 5.0 mm, in increments of 0.1 mm, or any range between 0.1 and 5.0 mm, e.g., from about 0.2 to about 0.4 mm. See, for example, d_{cwt} shown in FIG. 7B.
13. The die assembly 10 of any one of embodiments 1 to 12, wherein said first conduit structure 23 has an average first conduit inner diameter, d_{cid}, ranging from about 0.10 mm to about 1.50 mm, or any number between 0.10 and 1.50 mm, in increments of 0.01 mm, or any range between 0.10 and 1.50 mm, e.g., from about 0.10 to about 0.25 mm. See, for example, d_{cid} shown in FIG. 7B.
14. The die assembly 10 of any one of embodiments 1 to 13, wherein said die body housing 20 has an average housing wall thickness, d_{dbwt}, ranging from about 0.1 mm to about 5.0 mm, or any number between 0.1 and 5.0 mm, in increments of 0.1 mm, or any range between 0.1 and 5.0 mm, e.g., from about 0.2 to about 0.4 mm. See, for example, d_{dbwt} shown in FIG. 6.
15. The die assembly 10 of any one of embodiments 1 to 13, wherein said die body housing 11 further comprises (i) at least one air inlet 27 along an air inlet surface 29 of said die body housing 11, (ii) at least one air outlet 28 along an air outlet surface 61 of said die body housing 11, and (iii) an air flow pathway extending from said at least one air inlet 27 to said at least one air outlet 28, said air flow pathway being in fluid communication with outer surfaces 26 of said first conduit structure 23. It should be noted that, when present, the at least one air inlet 27 and the at least one air outlet 28 may each independently be present along any portion of the outer surface of die body housing 11 or multiple locations along the outer surface of die body housing 11.
16. The die assembly 10 of any one of embodiments 1 to 15, wherein said die body housing 11 further comprises (i) at least one air inlet 27 along an air inlet surface 29 of said die body housing 11, (ii) multiple air outlets 28 along an air outlet surface 61 of said die body housing 11, and (iii) an air flow pathway extending from said at least one air inlet 27 to said multiple air outlets 28, said air flow pathway being in fluid communication with outer surfaces 26 of said first conduit structure 23.
17. The die assembly 10 of embodiment 15 or 16, wherein said air outlet surface and said extrudant outlet surface 22 represent the same outer surface 22 of said die body housing 11.
18. The die assembly 10 of embodiment 16 or 17, wherein said multiple air outlets 28 are positioned along said extrudant outlet surface 22 so as to surround a majority of an outer perimeter 62 of each of said multiple first extrudant material outlets 14.
19. The die assembly 10 of any one of embodiments 1 to 18, wherein said die body housing 11 has outer dimensions comprising: an overall height h_{db} ranging from about 0.5 cm to about 40.0 cm, an overall length I_{db} ranging from about 0.5 cm to about 1000.0 cm, and an overall width w_{db} ranging from about 0.5 cm to about 100.0 cm. It should be understood that die body housing 11 may have any desired outer dimensions.
20. The die assembly 10 of any one of embodiments 1 to 19, wherein said die body 11 further comprises (i) a single second extrudant material inlet 13b (i.e., single first extrudant material inlet being shown as 13a) along said extrudant inlet surface 21 of said die body housing 11, (ii) multiple second extrudant material outlets 14b (i.e., multiple first extrudant material outlets being shown as 14a) along said extrudant outlet surface 22 of said die body housing 11, and (iii) a second conduit structure 23b connecting said single second extrudant material inlet 13b to said multiple second extrudant material outlets 13b (i.e., first conduit structure being shown as 23a). See, FIG. 8.
21. The die assembly 10 of embodiment 20, wherein said multiple second extrudant material outlets 14b are in a non-linear configuration along said extrudant outlet surface 22 of said die body housing 11.
22. The die assembly 10 of embodiment 20 or 21, wherein said void space 24 is between inner wall surfaces 25 of said die body housing 11 and outer surfaces 26b of said second conduit structure 23b.
23. The die assembly 10 of any one of embodiments 20 to 22, wherein said second multiple extrudant material outlets 14b comprise an equal number of outlets as said first extrudant material outlets 14a.
24. The die assembly 10 of any one of embodiments 20 to 23, wherein said second multiple extrudant material outlets 14b form an array of second extrudant material outlets 14b.
25. The die assembly 10 of any one of embodiments 20 to 24, wherein said second conduit structure 23b has an average second conduit wall thickness, d_{cwt}, ranging from about 0.1 mm to about 5.0 mm, or any number between 0.1 and 5.0 mm, in increments of 0.1 mm, or any range between 0.1 and 5.0 mm, e.g., from about 0.2 to about 0.4 mm.
26. The die assembly 10 of any one of embodiments 20 to 25, wherein said second conduit structure 23b has an average second conduit inner diameter, d_{cid}, ranging from about 0.10 mm to about 2.00 mm, or any number between 0.10 and 2.00 mm, in increments of 0.01 mm, or any range between 0.10 and 2.00 mm, e.g., from about 0.10 to about 0.25 mm.
27. The die assembly 10 of any one of embodiments 20 to 26, wherein said air flow pathway is in fluid communication with outer surfaces 26b of said second conduit structure 23b.
28. The die assembly 10 of any one of embodiments 20 to 27, wherein said multiple air outlets 28 are positioned along said extrudant outlet surface 22 so as to surround a majority of an outer perimeter 62 of each of said multiple second extrudant material outlets 14b.
29. The die assembly 10 of any one of embodiments 1 to 28, wherein said multiple first extrudant material outlets 14/14a of said die body 11 feed a first extrudant material (not shown) into a die tip 12/12′.
30. The die assembly 10 of any one of embodiments 20 to 29, wherein said multiple second extrudant material outlets 14b of said die body 11 feed a second extrudant material into a die tip 12/12′.
31. The die assembly 10 of any one of embodiments 1 to 30, in combination with a die tip 12/12′.
32. The die assembly 10 of embodiment 31, wherein said die tip 12 comprising (i) a die tip housing 30; (ii) multiple nozzles 31 extending through said die tip housing 30, each of said multiple nozzles 31 comprising (a) a nozzle inlet 32, (b) a nozzle outlet 33, (c) a nozzle conduit structure 34 extending from said nozzle inlet 31 to said nozzle outlet 32, and (d) a continuous nozzle inner surface 35 extending from said nozzle inlet 32 to said nozzle outlet 33; (iii) at least one die tip air inlet 36 along an air inlet surface 37 of said die tip housing 30; (iv) multiple die tip air outlets 38; and (v) a die tip air flow pathway extending from said at least one die tip air inlet 36 to said multiple die tip air outlets 38, said die tip air flow pathway being in fluid communication with an outer surface 39 of each of said multiple nozzles 31. See, FIGS. 10A-10C for exemplary nozzle 31 cross-sectional configurations. See, FIG. 11 for a better view of multiple die tip air outlets 38.
33. A die assembly 10 comprising: a die tip 12 comprising (i) a die tip housing 30; (ii) multiple nozzles 31 extending through said die tip housing 30, each of said multiple nozzles 31 comprising (a) a nozzle inlet 32, (b) a nozzle outlet 33, (c) a nozzle conduit structure 34 extending from said nozzle inlet 32 to said nozzle outlet 33, and (d) a continuous nozzle inner surface 35 extending from said nozzle inlet 32 to said nozzle outlet 33; (iii) at least one die tip air inlet 36 along an air inlet surface 37 of said die tip housing 12; (iv) multiple die tip air outlets 38; and (v) a die tip air flow pathway extending from said at least one die tip air inlet 36 to said multiple die tip air outlets 38, said die tip air flow pathway being in fluid communication with an outer surface 39 of each of said multiple nozzles 31; wherein said die tip 12 further comprises at least one of the following features: (1) air flow adjusters promimate to or connected to one or more of said multiple nozzles, said air flow adjusters 66 being operatively adapted to cause rotational air flow along said outer surface 39 of said one or more multiple nozzles 31 as air exits said die tip air outlets 38 associated with said one or more multiple nozzles 31; (2) a non-circular cross-sectional area for one or more nozzle holes 67 as measured substantially perpendicular to said continuous nozzle inner surface 35 of said nozzle conduit structure 34; (3) a nozzle inlet 32 cross-sectional area that is greater than a nozzle outlet 33 cross-sectional area for a nozzle conduit structure 34 within said multiple nozzles 31 as measured substantially perpendicular to said continuous nozzle inner surface 35 of said nozzle conduit structure 34; (4) one or more nozzle stabilizers 68 integrally connecting an outer surface 39 of a given nozzle conduit structure 34 to said die tip housing 12 proximate said multiple die tip air outlets 38 of said die tip housing 12; and (5) said continuous nozzle inner surface 35 has a length to diameter ratio greater than about 5:1.
34. The die assembly 10 of embodiment 33, wherein said die tip 12 comprises air flow adjusters 66 promimate to or connected to one or more of said multiple nozzles 31, said air flow adjusters 66 being operatively adapted to cause rotational air flow along said outer surface 39 of said one or more multiple nozzles 31 as air exits said die tip air outlets 38 associated with said one or more multiple nozzles 31.
35. The die assembly 10 of embodiment 33 or 34, wherein said air flow adjusters 66 are connected to at least one of said multiple nozzles 31.
36. The die assembly 10 of any one of embodiments 33 to 35, wherein said air flow adjusters 66 are connected to a majority of said multiple nozzles 31.
37. The die assembly 10 of any one of embodiments 33 to 36, wherein said die tip 12 further comprises a non-circular cross-sectional area for one or more nozzle holes 67 within said multiple nozzles 31 as measured substantially perpendicular to said continuous nozzle inner surface 35 of said nozzle conduit structure 34.
38. The die assembly 10 of embodiment 37, wherein a majority of said multiple nozzles 31 comprise a non-circular cross-sectional area for said nozzle holes 67.
39. The die assembly 10 of embodiment 37 or 38, wherein said non-circular cross-sectional area is selected from a tri-lobal shape, a triangular shape, a square shape, a star shape, a rectangular shape, and a cross shape. It should be noted that the non-circular cross-sectional area may have any desired non-circular cross-sectional area shape.
40. The die assembly 10 of any one of embodiments 33 to 39, wherein said die tip 12 further comprises a nozzle inlet 32 cross-sectional area that is greater than a nozzle outlet 33 cross-sectional area for a nozzle conduit structure 34 within said multiple nozzles 31 as measured substantially perpendicular to said continuous nozzle inner surface 35 of said nozzle conduit structure 34.
41. The die assembly 10 of embodiment 40, wherein at least one nozzle conduit structure 34 within said multiple nozzles 31 has a conical shape (see, for example, FIGS. 10B-10C) as viewed perpendicular to a plane dissecting said nozzle inlet 32 and said nozzle outlet 33.
42. The die assembly 10 of embodiment 40 or 41, wherein a majority of said multiple nozzles 31 comprise a nozzle inlet 32 cross-sectional area that is greater than a nozzle outlet 33 cross-sectional area.
43. The die assembly 10 of any one of embodiments 33 to 42, wherein said die tip 12 further comprises one or more nozzle stabilizers 68 integrally connecting an outer surface 39 of a given nozzle conduit structure 34 to said die tip housing 12 proximate said multiple die tip air outlets 38 of said die tip housing 12.
44. The die assembly 10 of any one of embodiments 33 to 43, wherein said die tip 12 further comprises one or more nozzles 31, wherein said continuous nozzle inner surface 35 of said one or more nozzles 31 has a length to diameter ratio greater than about 5:1.
45. The die assembly 10 of embodiment 44, wherein a majority of said multiple nozzles 31 comprise a continuous nozzle inner surface 35 having a length to diameter ratio greater than about 10:1.
46. The die assembly 10 of embodiment 44 or 45, wherein a majority of said multiple nozzles 31 comprise a continuous nozzle inner surface 35 having a length to diameter ratio greater than about 30:1.
47. The die assembly 10 of any one of embodiments 32 to 46, wherein said die tip 12 comprises from about 2 to about 64 nozzle outlets 33 per square cm, or any number of nozzle outlets 33 per square cm between 2 and 64 in increments of 1, or any range between 2 and 64, e.g., from about 5 to about 10 nozzle outlets 33 per square cm.
48. The die assembly 10 of any one of embodiments 32 to 47, wherein said nozzle inlet 32 of each of said multiple nozzles 31 are substantially within a first die tip plane, said nozzle outlet 33 of each of said multiple nozzles 31 are substantially within a second die tip plane, and said first die tip plane is substantially parallel with said second die tip plane.
49. The die assembly 10 of embodiment 48, wherein said first die tip plane is separated from said second die tip plane by a die tip distance ranging from about 0.5 cm to about 100.0 cm, or any number between 0.5 and 100.0 cm, in increments of 0.1 cm, or any range between 0.5 and 100.0 cm, e.g., from about 10.0 to about 25.0 cm.
50. The die assembly 10 of any one of embodiments 32 to 49, wherein said multiple nozzles 31 have an average nozzle wall thickness, d_{nwt}, ranging from about 0.1 mm to about 5.0 mm, or any number between 0.1 and 5.0 mm, in increments of 0.1 mm, or any range between 0.1 and 5.0 mm, e.g., from about 0.2 to about 0.4 mm. See, for example, d_{nwt} shown in FIG. 11. Typically, average nozzle wall thickness, d_{nwt}, ranges from about 0.2 mm to about 0.4 mm.
51. The die assembly 10 of any one of embodiments 32 to 50, wherein said multiple nozzles 31 have an average nozzle inner diameter, d_{nid}, ranging from about 0.1 mm to about 1.5 mm, or any number between 0.10 and 1.50 mm, in increments of 0.01 mm, or any range between 0.10 and 1.50 mm, e.g., from about 0.10 to about 0.25 mm. See, for example, d_{nid} shown in FIG. 11. Typically, average nozzle inner diameter, d_{nid}, ranges from about 0.10 mm to about 0.60 mm.
52. The die assembly 10 of any one of embodiments 32 to 51, wherein said die tip housing 12 has an average die tip housing wall thickness, d_{dtwt}, ranging from about 0.2 mm to about 10.0 mm, or any number between 0.2 and 10.0 mm, in increments of 0.1 mm, or any range between 0.2 and 10.0 mm, e.g., from about 0.4 to about 1.4 mm. See, for example, d_{dtwt} shown in FIG. 9. Typically, average die tip housing wall thickness, d_{dtwt}, ranges from about 0.2 mm to about 10.0 mm.
53. The die assembly 10 of any one of embodiments 32 to 52, wherein said die tip housing 12 has outer dimensions comprising: an overall height h_{dt} ranging from about 10.0 cm to about 100.0 cm, an overall length l_{dt} ranging from about 1.0 cm to about 1000.0 cm, and an overall width w_{dt} ranging from about 5.0 cm to about 300.0 cm. It should be understood that die tip housing 12 may have any desired outer dimensions.
54. The die assembly 10 of any one of embodiments 32 to 52, further comprising a die body 11 operatively adapted to feed at least one extrudant material (not shown) into said die tip 12.
55. The die assembly 10 of any one of embodiments 32 to 54, further comprising a die body 11 operatively adapted to feed at least one extrudant material into said die tip 12, said die body 11 comprising the die body 11 recited in any one of embodiments 1 to 30.
56. The die assembly 10 of embodiment 55, wherein said multiple first extrudant material outlets 14/14a feed first extrudant material into nozzle inlets 32 of said multiple nozzles 31.
57. The die assembly 10 of embodiment 55 or 56, wherein said multiple air outlets 28 of said die body 11 feed air from said die body 11 into said at least one die tip air inlet 36 of said die tip 12.
58. The die assembly 10 of any one of embodiments 55 to 57, wherein said die body 11 and said die tip 12 are integrally connected with one another as a single piece of continuous material.
59. The die assembly 10 of embodiment 58, wherein said first conduit structure 23 connects said single first extrudant material inlet 13 to all of the nozzle outlets 33 of said multiple nozzles 31.
60. The die assembly 10 of embodiment 58, wherein said first and second conduit structures 23a and 23b connect said single first and second extrudant material inlets 13a and 13b to all of the nozzle outlets 33 of said multiple nozzles 31.
61. A die assembly 10 comprising a die body 11 integrally connected to a die tip 12 so as to form a single piece of continuous material, said die assembly 10 comprising (i) a die assembly housing 50, (ii) a single first extrudant material inlet 13 along an extrudant inlet surface 51 of said die assembly housing 50, (iii) multiple first extrudant material nozzle outlets 33 extending through an extrudant outlet surface 52 of said die assembly housing 50, (iv) a first conduit structure 23 connecting said single first extrudant material inlet 13 to said multiple first extrudant material nozzle outlets 33 and forming multiple first nozzles 31, said multiple first extrudant material nozzle outlets 33 being in a non-linear configuration along said extrudant outlet surface 52 of said die assembly housing 50, (v) void space 24 between inner walls 25 of said die assembly housing 50 and outer surfaces 26 of said first conduit structure 23, (vi) at least one air inlet 27 along an air inlet surface (e.g., surface 51) of said die assembly housing 50 and (vii) multiple air outlets 38 positioned along said extrudant outlet surface 52, said multiple air outlets 38 being positioned so as to at least partially surround each of said first extrudant material nozzle outlets 33, at least a portion of said void space 24 forming an air flow pathway between said at least one air inlet 27 and said multiple air outlets 38.
62. The die assembly 10 of embodiment 61, wherein said first conduit structure 23 comprises two or more conduit junctions 82 therein, each conduit junction 82 splitting a conduit junction inlet fluid stream into two conduit junction fluid exit streams.
63. The die assembly 10 of embodiment 61 or 62, wherein said first conduit structure 23 comprises up to 2¹⁰ (i.e., 1024) conduit junctions 82 therein, each conduit junction 82 splitting a conduit junction inlet fluid stream into two conduit junction fluid exit streams. Typically, said first conduit structure 23 comprises from about 15 to about up to 127 conduit junctions 82 therein.
64. The die assembly 10 of any one of embodiments 61 to 63, wherein said extrudant inlet surface 51 is substantially within a first plane, said extrudant outlet surface 52 is within a second plane, and said first plane is substantially parallel with said second plane.
65. The die assembly 10 of embodiment 64, wherein said first plane is separated from said second plane by a die assembly housing distance, d_{da}, ranging from about 1.0 cm up to and including about 100.0 cm, or any number between 1.0 and 100.0 cm, in increments of 0.1 cm, or any range between 1.0 and 100 cm, e.g., from about 20.5 to about 40.3 cm. See, for example, d_{da} shown in FIG. 13.
66. The die assembly 10 of any one of embodiments 61 to 65, wherein said first conduit structure 23 has an average first conduit wall thickness, d_{cwt}, ranging from about 0.1 mm to about 5.0 mm, or any number between 0.1 and 5.0 mm, in increments of 0.1 mm, or any range between 0.1 and 5.0 mm, e.g., from about 0.2 to about 0.4 mm. See, for example, d_{cwt} shown in FIG. 7B. Same applies here.
67. The die assembly 10 of any one of embodiments 61 to 66, wherein said first conduit structure 23 has an average first conduit inner diameter, d_{cmt}, ranging from about 0.10 mm to about 1.50 mm, or any number between 0.10 and 1.50 mm, in increments of 0.01 mm, or any range between 0.10 and 1.50 mm, e.g., from about 0.10 to about 0.25 mm. See, for example, d_{cid} shown in FIG. 7B. Same applies here.
68. The die assembly 10 of any one of embodiments 61 to 67, wherein said die assembly housing 50 has an average die assembly housing wall thickness, d_{dawt}, ranging from about 0.2 mm to about 10.0 mm, or any number between 0.2 and 10.0 mm, in increments of 0.1 mm, or any range between 0.2 and 10.0 mm, e.g., from about 0.2 to about 0.8 mm. d_{dawt} would typically have similar dimensions as d_{dbwt} shown in FIG. 6.
69. The die assembly 10 of any one of embodiments 61 to 88, wherein said die assembly housing 50 has outer dimensions comprising: an overall height h_{da} ranging from about 0.5 cm to about 100.0 cm, an overall length I_{da} ranging from about 0.5 cm to about 1000.0 cm, and an overall width w_{da} ranging from about 0.5 cm to about 300.0 cm. It should be understood that die assembly housing 50 may have any desired outer dimensions.
70. The die assembly 10 of any one of embodiments 61 to 69, wherein said die assembly 10 further comprises (i) a single second extrudant material inlet 13b along said extrudant inlet surface 51 of said die assembly housing 50, (ii) multiple second extrudant material nozzle outlets 33b along said extrudant outlet surface 52 of said die assembly housing 50, and (iii) a second conduit structure 23b connecting said single second extrudant material inlet 13b to said multiple second extrudant material nozzle outlets 33b and forming multiple second nozzles 31b, said multiple air outlets 38 being positioned so as to at least partially surround each of said second extrudant material nozzle outlets 33b.
71. The die assembly 10 of embodiment 70, wherein said void space 24 is between inner wall surfaces 25 of said die assembly housing 50 and outer surfaces 26b of said second conduit structure 23b.
72. The die assembly 10 of embodiment 70 or 71, wherein said second multiple extrudant material nozzle outlets 33b comprise an equal number of nozzle outlets as said first extrudant material nozzle outlets 33a.
73. The die assembly 10 of any one of embodiments 70 to 72, wherein said second conduit structure 23b has an average second conduit wall thickness, d_{cwt}, ranging from about 0.1 mm to about 5.0 mm, or any number between 0.1 and 5.0 mm, in increments of 0.1 mm, or any range between 0.1 and 5.0 mm, e.g., from about 0.2 to about 0.4 mm.
74. The die assembly 10 of any one of embodiments 70 to 73, wherein said second conduit structure 23b has an average second conduit inner diameter, d_{cid}, ranging from about 0.10 mm to about 1.50 mm, or any number between 0.10 and 1.50 mm, in increments of 0.01 mm, or any range between 0.10 and 1.50 mm, e.g., from about 0.10 to about 0.25 mm.
75. The die assembly 10 of any one of embodiments 70 to 74, wherein said air flow pathway is in fluid communication with outer surfaces 26b of said second conduit structure 23b.
76. The die assembly 10 of any one of embodiments 61 to 75, wherein said die assembly 10 comprises air flow adjusters 66 promimate to or connected to said first conduit structure 23, said air flow adjusters 66 being operatively adapted to cause rotational air flow along said outer surface 26 of said first conduit structure 23 as air exits said multiple air outlets 38 along said multiple first nozzles 31.
77. The die assembly 10 of embodiment 76, wherein said air flow adjusters 66 are connected to said first conduit structure 23.
78. The die assembly 10 of embodiment 76 or 77, wherein said air flow adjusters 66 create rotational air flow along a majority of said multiple first extrudant material nozzle outlets 33.
79. The die assembly 10 of any one of embodiments 61 to 78, wherein said die assembly 10 further comprises a non-circular cross-sectional area along at least a portion of one or more first nozzle holes 67 formed within said multiple first nozzles 31, as measured substantially perpendicular to a continuous nozzle inner surface 35 of said multiple first nozzles 31.
80. The die assembly 10 of embodiment 79, wherein a majority of said nozzle holes 67 of said multiple first nozzles 31 comprise a non-circular cross-sectional area.
81. The die assembly 10 of embodiment 79 or 80, wherein said non-circular cross-sectional area is selected from a tri-lobal shape, a triangular shape, a square shape, a star shape, a rectangular shape, and a cross shape.
82. The die assembly 10 of any one of embodiments 61 to 81, wherein at least a portion of said multiple first nozzles 31 comprises a nozzle inlet 32 cross-sectional area that is greater than a nozzle outlet 33 cross-sectional area for one or more nozzles 31 within said multiple first nozzles 31 as measured substantially perpendicular to a continuous nozzle inner surface 35 of said multiple first nozzles 31.
83. The die assembly 10 of embodiment 82, wherein at least one nozzle 31 within said multiple first nozzles 31 has a conical shape (see, for example, FIGS. 10B-10C) as viewed perpendicular to a plane dissecting said first nozzle inlet 32 and said first nozzle outlet 33.
84. The die assembly 10 of embodiment 82 or 83, wherein a majority of said multiple first nozzles 31 comprise a nozzle inlet 32 cross-sectional area that is greater than a nozzle outlet 33 cross-sectional area.
85. The die assembly 10 of any one of embodiments 61 to 84, wherein said die assembly 10 further comprises one or more nozzle stabilizers 68 integrally connecting (i) an outer surface 39 of each of said multiple first nozzles 31 to (ii) said die assembly housing 50 proximate said multiple air outlets 38 of said die assembly housing 50.
86. The die assembly 10 of any one of embodiments 61 to 85, wherein each of said multiple first nozzles 31 has a length to diameter ratio greater than about 5:1.
87. The die assembly 10 of embodiment 86, wherein a majority of said multiple first nozzles 31 comprise a continuous nozzle inner surface 35 having a length to diameter ratio greater than about 10:1.
88. The die assembly 10 of embodiment 86 or 87, wherein a majority of said multiple first nozzles 31 comprise a continuous nozzle inner surface 35 having a length to diameter ratio greater than about 30:1.
89. The die assembly 10 of any one of embodiments 61 to 88, wherein said die assembly 10 comprises from about 2 to about 64 nozzle outlets 33 per square cm.
90. The die assembly 10 any one of embodiments 1 to 89, wherein said die assembly 10 comprises stainless steel.
91. The die assembly 10 any one of embodiments 1 to 90, wherein said die assembly 10 is disposable (i.e., is used for a period of time and then disposed of as opposed to cleaned and re-used).

Methods of Making Die Assembly Embodiments

92. A method of making the die assembly 10 of any one of embodiments 1 to 91, said method comprising: forming a pre-formed die assembly (not shown) via one or more three-dimensional printing steps.
93. The method of embodiment 92, further comprising: heating the pre-formed die assembly at a temperature and period of time so as to consolidate the pre-formed die assembly into the die assembly 10. For example, the pre-formed die assembly may be sintered at a temperature ranging from about 1000° C. up to and including about 1400° C., or any temperature between about 1000° and 1400° C. in increments of 1.0° C., or any range of temperatures between about 1000° and 1400° C., e.g., from about 1200° to about 1350° C., for a period of time ranging from about 20 minutes up to and including about 90 minutes, or any number of minutes between about 20 and 90 minutes in increments of 1.0 minute, or any range between about 20 and 90 minutes, e.g., from about 45 to about 60 minutes.
94. The method of embodiment 92 or 93, wherein said one or more three-dimensional printing steps comprise forming a die body 11.
95. The method of embodiment 94, connecting the die body 11 to a conventional die tip 12′.
96. The method of embodiment 92 or 93, wherein said one or more three-dimensional printing steps comprise forming a die tip 12.
97. The method of embodiment 96, connecting the die tip 12 to a conventional die body 11′.
98. The method of embodiment 96, connecting the die tip 12 to the die body 11 formed in claim 94.
99. The method of embodiment 92 or 93, wherein said one or more three-dimensional printing steps comprise forming a die body 11 that is integrally connected to a die tip 12. See, FIG. 13.

Methods of Using Die Assembly Embodiments

100. A method of using the die assembly 10 of any one of embodiments 1 to 91, said method comprising: extruding a material (not shown) through the die assembly 10.
101. The method of embodiment 100, wherein the material comprises at least one polymeric material.
102. The method of embodiment 100 or 101, wherein the at least one polymeric material comprises two or more polymeric materials.
103. The method of embodiment 101 or 102, wherein the at least one polymeric material comprises polypropylene, polyethylene, polyester, polyamide, polylactic acid (PLA), polyvinyl alcohol (PVOH), polyvinyl acetate (PVA), or any combination thereof.
104. The method of any one of embodiments 100 to 103, wherein said extruding step forms monocomponent fibers.
105. The method of any one of embodiments 100 to 103, wherein said extruding step forms bi- or multi-component fibers.
106. The method of embodiment 105, wherein the bi- or multi-component fibers comprise fibers having an island-in-the-sea configuration.
107. The method of embodiment 105, wherein the bi- or multi-component fibers comprise fibers having a sheath/core cross-sectional configuration.
108. The method of any one of embodiments 100 to 107, wherein said extruding step forms a nonwoven fabric.
109. The method of any one of embodiments 100 to 108, wherein said extruding step forms a meltblown nonwoven fabric.
110. The method of any one of embodiments 100 to 109, further comprising: disposing of the die assembly 10 following said extruding step.
111. The method of embodiment 110, wherein said disposing step is performed without any cleaning steps between said extruding step and said disposing step.
112. The method of any one of embodiments 100 to 111, further comprising: replacing the die assembly 10 with a disposable die assembly 10.
113. The method of any one of embodiments 100 to 112, wherein said method utilizes less than about 2000 Watts of heat energy/linear inch of the die assembly 10 during said extruding step (or any number below 2000 Watts of heat energy/linear inch, in increments of 1.0 Watts of heat energy/linear inch, or any range between about 100 and 2000 Watts of heat energy/linear inch, e.g., from about 500 to about 1000 Watts of heat energy/linear inch).
114. The method of any one of embodiments 100 to 113, wherein said method utilizes less than about 1800 Watts of heat energy/linear inch of the die assembly 10 during said extruding step.
115. The method of any one of embodiments 100 to 110, wherein said method utilizes less than about 1500 Watts of heat energy/linear inch of the die assembly 10 during said extruding step.
116. The method of any one of embodiments 100 to 115, wherein said method utilizes less than about 1000 Watts of heat energy/linear inch of the die assembly 10 during said extruding step.
117. The method of any one of embodiments 100 to 116, wherein said method utilizes less than about 800 Watts of heat energy/linear inch of the die assembly 10 during said extruding step.

It should be understood that although the above-described die assemblies 10, die assembly components (e.g., die body 11, die tip 12, etc.) and methods are described as “comprising” one or more components, features or steps, the above-described die assemblies 10, die assembly components (e.g., die body 11, die tip 12, etc.) and methods may “comprise,” “consists of,” or “consist essentially of” any of the above-described components and/or features and/or steps of the die assemblies 10, die assembly components (e.g., die body 11, die tip 12, etc.) and methods. Consequently, where the present invention, or a portion thereof, has been described with an open-ended term such as “comprising,” it should be readily understood that (unless otherwise stated) the description of the present invention, or the portion thereof, should also be interpreted to describe the present invention, or a portion thereof, using the terms “consisting essentially of” or “consisting of” or variations thereof as discussed below.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a die assembly 10, a die assembly component (e.g., die body 11, die tip 12, etc.) and/or method that “comprises” a list of elements (e.g., components or features or steps) is not necessarily limited to only those elements (or components or features or steps), but may include other elements (or components or features or steps) not expressly listed or inherent to the die assembly 10, die assembly component (e.g., die body 11, die tip 12, etc.) and/or method.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a die assembly 10, a die assembly component (e.g., die body 11, die tip 12, etc.) and/or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Further, it should be understood that the herein-described die assemblies 10, die assembly components (e.g., die body 11, die tip 12, etc.) and/or methods may comprise, consist essentially of, or consist of any of the herein-described components and features, as shown in the figures with or without any additional feature(s) not shown in the figures. In other words, in some embodiments, the die assembly 10, the die assembly component (e.g., die body 11, die tip 12, etc.) and/or method of the present invention may have any additional feature that is not specifically shown in the figures. In some embodiments, the die assembly 10, die assembly component (e.g., die body 11, die tip 12, etc.) and/or method of the present invention does not have any additional features other than those (i.e., some or all) shown in the figures, and such additional features, not shown in the figures, are specifically excluded from the die assembly 10, die assembly component (e.g., die body 11, die tip 12, etc.) and/or method.

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### Example 1

### Preparation of Die Assembly Components

Die assemblies and die assembly components similar to exemplary die assembly 10 and die assembly components 11 and 12 shown in FIGS. 5-13 were prepared using a three-dimensional printing operation.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A die assembly comprising:
a die body comprising (i) a die body housing, (ii) a single first extrudant material inlet along an extrudant inlet surface of said die body housing, (iii) multiple first extrudant material outlets along an extrudant outlet surface of said die body housing, and (iv) a first conduit structure connecting said single first extrudant material inlet to said multiple first extrudant material outlets, said multiple first extrudant material outlets being in a non-linear configuration along said extrudant outlet surface of said die body housing.

2. The die assembly of claim 1, wherein said die body further comprises (v) void space between inner wall surfaces of said die body housing and outer surfaces of said first conduit structure.

3. A die assembly comprising:
a die body comprising (i) a die body housing, (ii) a single first extrudant material inlet along an extrudant inlet surface of said die body housing, (iii) multiple first extrudant material outlets along an extrudant outlet surface of said die body housing, (iv) a first conduit structure connecting said single first extrudant material inlet to said multiple first extrudant material outlets, and (v) void space between inner wall surfaces of said die body housing and outer surfaces of said first conduit structure.

4. The die assembly of claim 3, wherein said multiple first extrudant material outlets are in a non-linear configuration along said extrudant outlet surface of said die body housing.

5. The die assembly of claim 4, wherein said multiple first extrudant material outlets comprise four or more first extrudant material outlets in multiples of 2.

6. The die assembly of claim 5, wherein said multiple first extrudant material outlets comprise from about 16 to about 128 first extrudant material outlets.

7. The die assembly of claim 6, wherein said multiple first extrudant material outlets form an array of first material extrudant outlets along said extrudant outer surface, said array comprising (i) at least four first extrudant material outlets in a x direction and (ii) at least four first extrudant material outlets in a y direction.

8. The die assembly of claim 1, wherein said extrudant inlet surface is substantially within a first plane, said extrudant outlet surface is within a second plane, and said first plane is substantially parallel with said second plane.

9. The die assembly of claim 8, wherein said first plane is separated from said second plane by a housing distance ranging from about 0.5 centimeters (cm) to about 10.0 cm.

10. The die assembly of claim 1, wherein said first conduit structure has an average first conduit wall thickness ranging from about 0.1 millimeters (mm) to about 5.0 mm, and an average first conduit inner diameter ranging from about 0.10 mm to about 1.50 mm.

11. The die assembly of claim 1, wherein said die body housing has an average housing wall thickness ranging from about 0.1 mm to about 5.0 mm.

12. The die assembly of claim 1, wherein said die body housing further comprises (i) at least one air inlet along an air inlet surface of said die body housing, (ii) at least one air outlet along an air outlet surface of said die body housing, and (iii) an air flow pathway extending from said at least one air inlet to said at least one air outlet, said air flow pathway being in fluid communication with outer surfaces of said first conduit structure.

13. The die assembly of claim 3, wherein said die body housing further comprises (i) at least one air inlet along an air inlet surface of said die body housing, (ii) multiple air outlets along an air outlet surface of said die body housing, and (iii) an air flow pathway extending from said at least one air inlet to said multiple air outlets, said air flow pathway being in fluid communication with outer surfaces of said first conduit structure.

14. The die assembly of claim 13, wherein said air outlet surface and said extrudant outlet surface represent the same outer surface of said die body housing.

15. The die assembly of claim 13, wherein said multiple air outlets are positioned along said extrudant outlet surface so as to surround a majority of an outer perimeter of each of said multiple first extrudant material outlets.

16. The die assembly of claim 1, wherein said die body housing has outer dimensions comprising: an overall height ranging from about 0.5 cm to about 10.0 cm, an overall length ranging from about 0.5 cm to about 1000.0 cm, and an overall width ranging from about 0.5 cm to about 100.0 cm.

17. The die assembly of claim 1, wherein said die body further comprises (i) a single second extrudant material inlet along said extrudant inlet surface of said die body housing, (ii) multiple second extrudant material outlets along said extrudant outlet surface of said die body housing, and (iii) a second conduit structure connecting said single second extrudant material inlet to said multiple second extrudant material outlets;
wherein (1) said multiple second extrudant material outlets are in a non-linear configuration along said extrudant outlet surface of said die body housing, and (2) said void space is between inner wall surfaces of said die body housing and outer surfaces of said second conduit structure.

18. The die assembly of claim 1, in combination with a die tip.

19. The die assembly of claim 18, wherein said die tip comprising (i) a die tip housing; (ii) multiple nozzles extending through said die tip housing, each of said multiple nozzles comprising (a) a nozzle inlet, (b) a nozzle outlet, (c) a nozzle conduit structure extending from said nozzle inlet to said nozzle outlet, and (d) a continuous nozzle inner surface extending from said nozzle inlet to said nozzle outlet; (iii) at least one die tip air inlet along an air inlet surface of said die tip housing; (iv) multiple die tip air outlets; and (v) a die tip air flow pathway extending from said at least one die tip air inlet to said multiple die tip air outlets, said die tip air flow pathway being in fluid communication with an outer surface of each of said multiple nozzles.

20. A die assembly comprising:
a die tip comprising (i) a die tip housing; (ii) multiple nozzles extending through said die tip housing, each of said multiple nozzles comprising (a) a nozzle inlet, (b) a nozzle outlet, (c) a nozzle conduit structure extending from said nozzle inlet to said nozzle outlet, and (d) a continuous nozzle inner surface extending from said nozzle inlet to said nozzle outlet; (iii) at least one die tip air inlet along an air inlet surface of said die tip housing; (iv) multiple die tip air outlets; and (v) a die tip air flow pathway extending from said at least one die tip air inlet to said multiple die tip air outlets, said die tip air flow pathway being in fluid communication with an outer surface of each of said multiple nozzles;
wherein said die tip further comprises at least one of the following features:
(1) air flow adjusters promimate to or connected to one or more of said multiple nozzles, said air flow adjusters being operatively adapted to cause rotational air flow along said outer surface of said one or more multiple nozzles as air exits said die tip air outlets associated with said one or more multiple nozzles;
(2) a non-circular cross-sectional area for one or more nozzle holes as measured substantially perpendicular to said continuous nozzle inner surface of said nozzle conduit structure;
(3) a nozzle inlet cross-sectional area that is greater than a nozzle outlet cross-sectional area for a nozzle conduit structure within said multiple nozzles as measured substantially perpendicular to said continuous nozzle inner surface of said nozzle conduit structure;
(4) one or more nozzle stabilizers integrally connecting an outer surface of a given nozzle conduit structure to said die tip housing proximate said multiple die tip air outlets of said die tip housing; and
(5) said continuous nozzle inner surface has a length to diameter ratio greater than about 5:1.

21. The die assembly claim 10, wherein said die assembly is disposable.

22. A method of making the die assembly of claim 3, said method comprising:
forming a pre-formed die assembly via one or more three-dimensional printing steps; and
heating the pre-formed die assembly at a temperature ranging from about 1200 to 1350° C. for a period of time of from about 30 to about 60 minutes so as to consolidate the pre-formed die assembly into the die assembly.

23. A method of using the die assembly of claim 3, said method comprising:
extruding a material through the die assembly,
wherein said method utilizes less than about 1000 Watts of heat energy/linear inch of the die assembly during said extruding step.
